(19) United States
(12) Patent Application Publication
(10) Pub. No.: US 2007/0103103 A1
(43) Pub. Date: May 10, 2007

(54) Bi-directional motor voltage conversion circuit

(76) Inventors: H. Winston Maue, Farmington Hills, MI (US); John F. Nathan, White Lake, MI (US); Naoko Kawahara, Yawata-shi (JP); Scott R. Gauss, Shelby Township, MI (US); Craig G. Goodman, Green Bay, WI (US); Daryl G. Petricca, Novi, MI (US); Jonathan Wenc, Chicago, IL (US)

Correspondence Address: MACMILLAN, SOBANSKI & TODD, LLC, ONE MARITIME PLAZA-FIFTH FLOOR, 720 WATER STREET, TOLEDO, OH, 43604, US

(21) Appl. No.: 11/270,022

(22) Filed: Nov. 9, 2005

(51) Int. Cl. H02P 1/00; H02P 3/00

(52) U.S. Cl. 318/280

(57) ABSTRACT

A DC motor circuit is provided for an automobile accessory that includes biplolar input lines for driving an accessory motor. A bridge rectifier coupled to the bipolar input lines generates a unipolar output. A transient voltage suppressor is connected in parallel with the bridge rectifier. A voltage regulator is coupled to the unipolar output for generating a regulated DC voltage. A position encoder is powered by the regulated DC voltage.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM LISTING COMPACT DISC APPENDIX

Not Applicable

### BACKGROUND OF THE INVENTION

1. Field of the Invention

This invention relates in general to a motor supply circuit, and more specifically, to a bipolar voltage conversion motor supply circuit.

2. Description of the Related Art

Bi-directional small motors are commonly used for vehicle applications devices that require bidirectional movement such as a power seating system. These motors operate in a forward rotational direction and a reverse rotational direction. To operate the motor in a first rotational direction, a bipolar input voltage is provided to the input terminals of the motor to drive the motor in the first rotational direction (e.g., clockwise). To operate the motor in the reverse direction, the polarity of supply voltage is switched so that an opposite bipolar voltage input is provided to the input terminals for driving the motor in a second rotational direction (e.g., counterclockwise).

With respect to seat motors, and in particular for applications having seat memory, a seat controller maintains a current rotational position of the motor via a rotational position sensor so that when a stored memory seat button is actuated, the seat controller can control the polarity of the power supplied to the motor for directionally driving the motor to the position correlating to the seat position stored in memory.

The rotational position sensor is used to sense the rotational position of a gear member within the motor. The gear member is coupled to the gear output shaft at a first end of the shaft and is coupled to the accessory device gear output shaft at a second end. By knowing the direction and degree of rotational movement that the gear member of the motor has rotated, the seat controller can correlate the rotational position of the gear member to the positional movement of the seat (e.g., forward/backward motion). Other movements such as recline, tilt, and up/down may be correlated in a similar manner.

The rotational position sensor is typically powered by a unipolar voltage. The rotational position sensor receives the unipolar voltage (typically 5 volts) via a circuit separate than the circuit used to energize the electromagnetic armature. Since the motor requires that the polarity be switched for driving the motor between a forward or reverse direction, polarity on a respective circuit will vary. For this reason, a circuit providing power to energize the electromagnetic armature is used separately from the circuit used to power the rotational position sensor. As a result, additional cost and packaging space is required for the additional circuits required to energize the rotational position sensor and electromagnetic armature within the motor.

### BRIEF SUMMARY OF THE INVENTION

The present invention has the advantage of powering both the position encoder and the electromagnetic armature utilizing the same voltage supply circuit input to the motor.

In one aspect of the present invention, a DC motor circuit is provided for an automobile accessory that includes biplolar input lines for driving an accessory motor. A bridge rectifier coupled to the bipolar input lines generates a unipolar output. A transient voltage suppressor is connected in parallel with the bridge rectifier. A voltage regulator is coupled to the unipolar output for generating a regulated DC voltage. A position encoder is powered by the regulated DC voltage.

### BRIEF DESCRIPTION OF THE DRAWINGS

FIG. 1 is a side view of a prior art illustration of an electric motor.

FIG. 2 is an elevation view of the prior art illustration of the electric motor of FIG. 1

FIG. 3 is a schematic of a first connector for the prior art electric motor as shown in FIG. 1.

FIG. 4 is a schematic of a second connector for the prior art electric motor as shown in FIG. 1.

FIG. 5 is a side view of an electric motor according to a preferred embodiment of the present invention.

FIG. 6 is an elevation view of the electric motor according to the preferred embodiment of the present invention.

FIG. 7 is a schematic of an electrical power supply circuit according to the preferred embodiment of the present invention.

FIG. 8 is a perspective view of the connector of the electric motor according to the preferred embodiment of the present invention.

### DETAILED DESCRIPTION OF THE PREFERRED EMBODIMENT

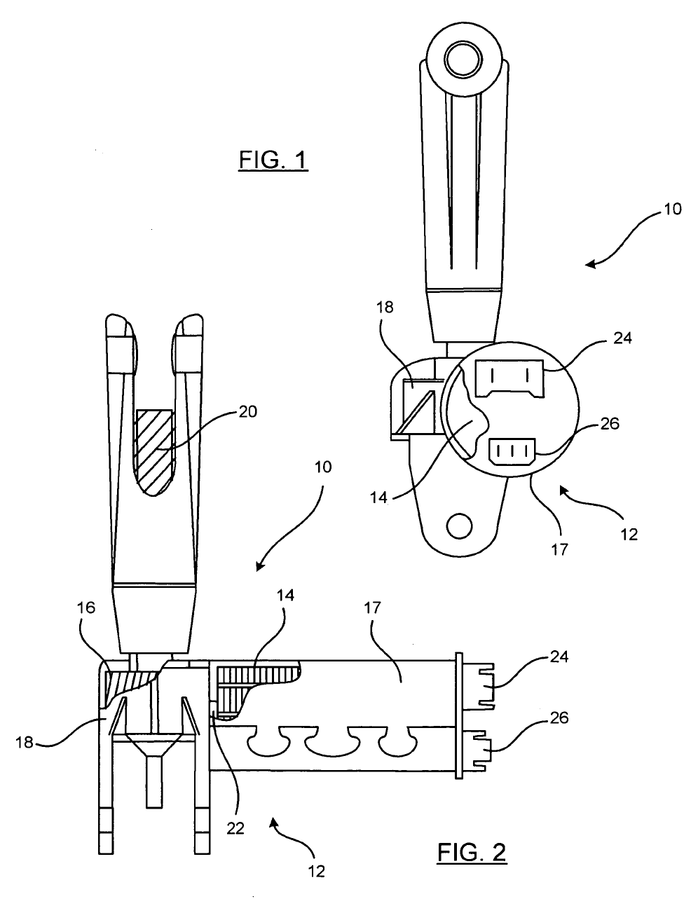

Referring now to the drawings, there is illustrated in FIG. 1 and FIG. 2 a side view and an elevation view, respectively, of a prior art electromagnetic motor 10, such as a seat motor. The motor 10 includes a motor housing 12 enclosing a plurality of subcomponents such as an electromagnetic armature 14 and a gear member 16. The motor housing 12 typically includes a plurality of subcomponent housings such as an armature housing 17 enclosing the electromagnetic armature 14, and a gear housing 18 enclosing the gear member 16 and an intermediate worm gear (not shown). The electromagnetic armature 14 includes a shaft 22 with a worm gear that is axially aligned and coupled to the intermediate worm gear. The intermediate worm gear includes helical threads that operably engage the gear member 16 thereby providing a drive means for operating an accessory device (not shown) such as a power seat or the like. The intermediate worm gear increases the gear reduction between the electromagnetic armature 14 and the gear member 16. Furthermore, the angle of the helical thread of the intermediate worm gear to the teeth of the gear member 16 prevents the motor from being manually back-driven. A gear output shaft 20 is integrally formed to the gear member 16 at one end of the shaft and is coupled to the accessory device at the other end of the shaft (i.e., external to the motor 10) for driving the accessory device. The prior art motor housing 12 further includes a first connector 24 and a second connector 26.

FIG. 3 is a schematic of the first connector 24 (as shown in FIG. 1) for powering the motor 10. The first connector 24 includes a first terminal contact 28 and a second terminal contact 30. The first connector 24 receives an input voltage via the first terminal 28 and second terminal 30 and supplies the input voltage to the electrical subcomponents of the motor 10 for driving the motor (e.g., to commutator brushes for commutating the armature in a permanent magnet DC motor or to a stator field in a brushless switch reluctance motor). Typical input voltage supplied to the motor is +/−12 to 14 volts. For a motor that requires switchable input voltage for driving the motor in a forward and reverse direction (e.g., seat motor or window lift motor), the input voltage is switched, typically using an H-bridge, prior to supplying the voltage to the first and second terminal contacts 28 and 30. For example, a positive voltage on terminal contact 28 and a negative voltage (ground in the case of DC voltage input) on terminal contact 30 will drive the motor 10 in a forward direction, whereas switching the polarity of the voltage to provide a positive voltage on terminal contact 30 and a negative voltage on terminal contact 28 will drive the motor 10 in a reverse direction. The switchable input voltage is controlled by a controller and an H-bridge circuit (not shown).

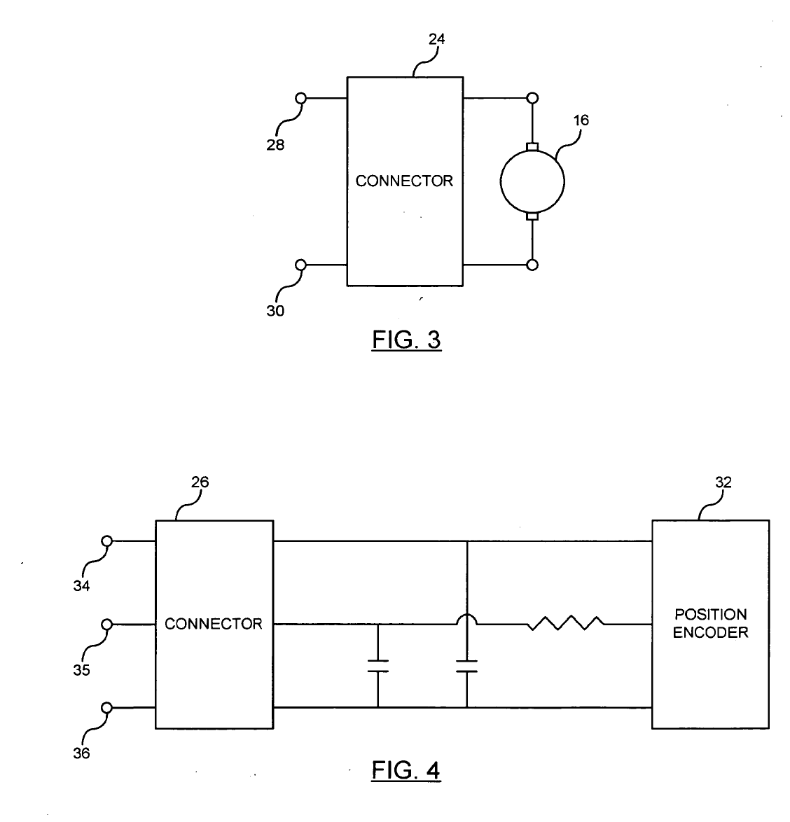

FIG. 4 illustrates a schematic of the second connector 26 (as shown in FIG. 1) for powering a position encoder 32 such as a non-contact position sensor. The second connector 26 is a three terminal connector. The second connector 26 includes a first terminal contact 34, a second terminal contact 35, and a third terminal contact 36. The connector 26 receives an input voltage for powering the position encoder 32 via the first terminal contact 34 and the third terminal contact 36. Unlike the switchable bipolar input voltage supplied to terminal contacts 28 and 30 for powering the motor 10, the input voltage provided to the position encoder 32 is a unipolar voltage, such as +5 V. As a result, a first set of electrical conduits and a second set electrical conduits are used to provide respective input voltages to the motor 10 to energize the armature 14 of the motor 10 and power the position encoder 32, respectively. The second terminal contact 35 of the second connector 26 is electrically connected to the position encoder 32 for outputting a sensed position signal from the position encoder 32 for identifying the rotational position of the gear member 16 within the motor 10.

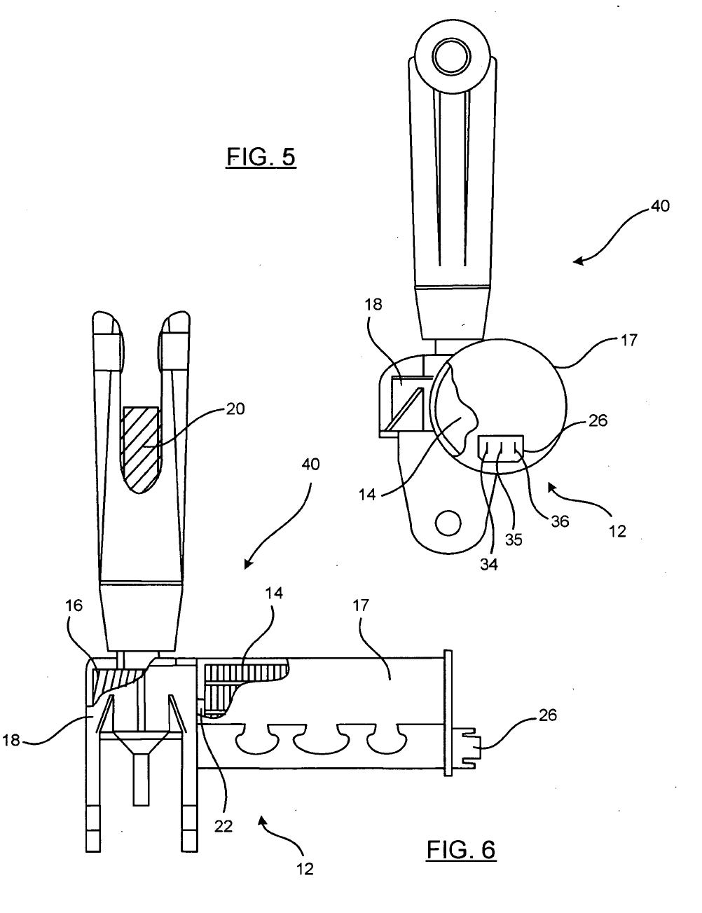

FIGS. 5 and 6 illustrate a side view and an elevation view, respectively, of a motor according to a preferred embodiment of the present invention. Using the same element numbers as described in FIG. 1 for like references, the motor is shown generally at 40. The motor 40 includes the motor housing 12 having an armature housing 17 and gear housing 18. The gear housing 18 includes the second connector 26 having the three terminal contacts 34, 35, and 36. Connector 26 provides input voltage for energizing both the electromagnetic armature 14 and a position encoder 32 (shown in FIG. 7) and for outputting sensed position signal from the position encoder 32.

FIG. 7 is an electrical schematic for supplying input voltage for powering the motor and the position encoder according to a preferred embodiment of the present invention. An H-bridge circuit 41 is electrically connected to an external power source 42, such as a vehicle battery (not shown). The connector 26 is connected to the H-bridge circuit 41 through the first terminal contact 34 and the third terminal contact 36. Bipolar input lines 44 are electrically connected from the connector 26 to electrical subcomponents within the motor 40. The bipolar input lines 44 are junctioned for providing a parallel voltage to a conversion circuit 45 and the electromagnetic armature 14. The conversion circuit 45 includes a bridge rectifier 46 coupled to the bipolar input lines 44. The conversion circuit 45 further includes a transient voltage suppressor 48 connected in parallel with the bridge rectifier 46. A first capacitor 50 is connected in parallel with the transient voltage suppressor 48. Also within the conversion circuit 45 is a voltage regulator 52 coupled to the output of the bridge rectifier 46, the transient voltage suppressor 48, and the capacitor 50, respectively. A second capacitor 54 is coupled to the output of a voltage regulator 52 and is electrically connected in parallel to the position encoder 32.

In operation, the input voltage 42 supplied by the external power source is input to the H-bridge circuit 41. H-Bridge circuits are commonly known in the art and are typically constructed using relays and switches, bipolar transistors, MOSFET transistors, power MOSFET's, FET transistors, or microchips that draw low current. The H-bridge circuit can be used for driving a motor forward or backward. This is typically accomplished by switching the voltage between positive to negative (or ground) on the motor leads for reversing the direction of a motor. The voltage is thereafter switched again to drive the motor in the forward direction when required.

The switched output voltage generated by the H-bridge circuit 41 is provided to the connector 26 typically mounted on the motor housing 12 (i.e., gear cover 20). The connector 34, as discussed earlier, includes the first and third contact terminals 34 and 36 for receiving the switched bi-polar voltage from the H-bridge circuit 41 and providing it to the bipolar input lines 44 within the motor 40. Junction nodes 43a and 43b divides the bipolar input lines 44 for energizing the electromagnetic armature 14 and for providing the bipolar voltage to the conversion circuit 45. The bipolar input voltage is provided to the electrical subcomponents for energizing the electromagnetic armature 14. The various types of motors and electrical subcomponents used to energize the armature are commonly known. The type of motor used will determine which electrical subcomponents are supplied with the bipolar voltage for energizing the electromagnetic armature. The various types of motors include, but are not limited to, a DC brush motor that includes a permanent magnet motor, separately excited DC motor, a series-wound DC motor, brushless motors, AC motors, or switch reluctance motors.

The switchable bipolar voltage provided to the conversion circuit 45 is received by the bridge rectifier 46. The bridge rectifier 46, commonly known as a full-wave rectifier, provides a same polarity output voltage and current for any respective input voltage. That is, whether a positive or negative input voltage is applied across the bipolar input lines 44, the bridge rectifier 46 rectifies the input voltage so that a same polarity voltage is output from the bridge rectifier 46 each time current flows therethrough regardless of the plurality of the bipolar input voltage.

The transient voltage suppressor 48 is connected in parallel to the output of the bridge rectifier 46. The transient voltage suppressor 48 is a clamping device that suppresses sudden voltage increases (i.e., such as voltage spikes) generated by the motor 40. Typically, large transient spikes are generated when dynamic braking occurs within the motor 40. Dynamic braking of a motor involves connecting both fields of a motor to a same polarity input/output (i.e., both fields tied to ground, or both to positive). Connecting both sides of the field to the same polarity causes the motor to stop instantaneously as opposed to coasting to a stop. The energy leaving both sides of the field electromagnetically locks the armature in place since there is a same electromagnetic force exerted on each respective field of the motor. When this occurs, back emf generated within the motor 40 can typically range upwards of 100 Volts. Large transient spikes can damage the electrical circuitry of the motor 40 , more specifically, the position encoder 32. The transient voltage suppressor 46 suppresses voltage increases above a predetermined voltage (e.g. clamping voltage above 23 Volts), and as a result, limits the voltage spikes to safe operating levels while directing damaging currents away from the position encoder 32.

The first capacitor 50 is connected in parallel with the bridge rectifier 46 and the transient voltage suppressor 48 for reducing electrical noise during low operating voltage operations and for reducing voltage spikes that occur below that which the transient voltage suppressor 48 is rated for. Furthermore, the energy stored and output by the capacitor 50 may lessen any variation of the output of the bridge rectifier 46 caused from any voltage drops in the output voltage or current output from the rectifier bridge 46.

The voltage regulator 52 receives the unipolar output voltage of the bridge rectifier 46 for regulating the DC voltage that is provided to the position encoder 32. The voltage regulator 52 receives the unipolar output voltage from the bridge rectifier 46, which may potentially vary, and converts it to a constant regulated voltage. Preferably, the unipolar output voltage from the bridge rectifier 46 is stepped down and regulated to 5 volts for powering the position encoder 32. Alternatively, voltages other than 5 volts may be used (e.g., 5-15 volts) depending on the operating input voltages of the position encoder utilized. The regulated voltage is provided to the position encoder 32 via circuits 60 and 62.

An energy storage device 54, such as a second capacitor, may be connected in parallel to the position encoder 32 for storing the regulated voltage output from the voltage regulator 52. The energy storage device 54 may be used to store and supply voltage to the position encoder 32 when voltage variances occur in the voltage output from the voltage regulator 52.

The position encoder 32 is preferably a non-contact sensor, such as a hall-effect sensor or potentiometer. The position encoder 32 monitors the rotational position of the gear member 16 within the gear housing 18. A position signal is generated identifying the rotational position of the gear member 14 within the gear housing 18 and is then output via circuit 61 to the connector 26. Based on the type position encoder 32 used, the position signal may be a relative position signal based on the alignment of sensed device to the magnetic field as it rotates in and out of a magnetic field or may be an absolute position where the absolute position of the sensed device on the rotating gear member 14 is known at all times. The position signal is then output from the connector 26 via terminal contact 35 to a controller (not shown) for correlating the rotational position of the gear member 14 to a position of an attaching accessory device being driven by the motor 40.

The output of the position encoder 32 is an open collector transistor requiring pull-up resister 63 (e.g., 1.8 kohms) to provide an output position signal between 0 and 5 volts. For example, if the position encoder 32 is a Hall-effect sensor (digital), then the output position signal will be either 0 or 5 volts. If the position encoder 32 is a potentiometer, then the output position signal can vary between 0 and 5 volts Alternatively, a 5 volt power source with the pull-up resistor may be connected to the circuit (external to the motor 40) extending from contact terminal 35 to the controller in place of pull-up resistor 63 connected between circuit 60 and 61.

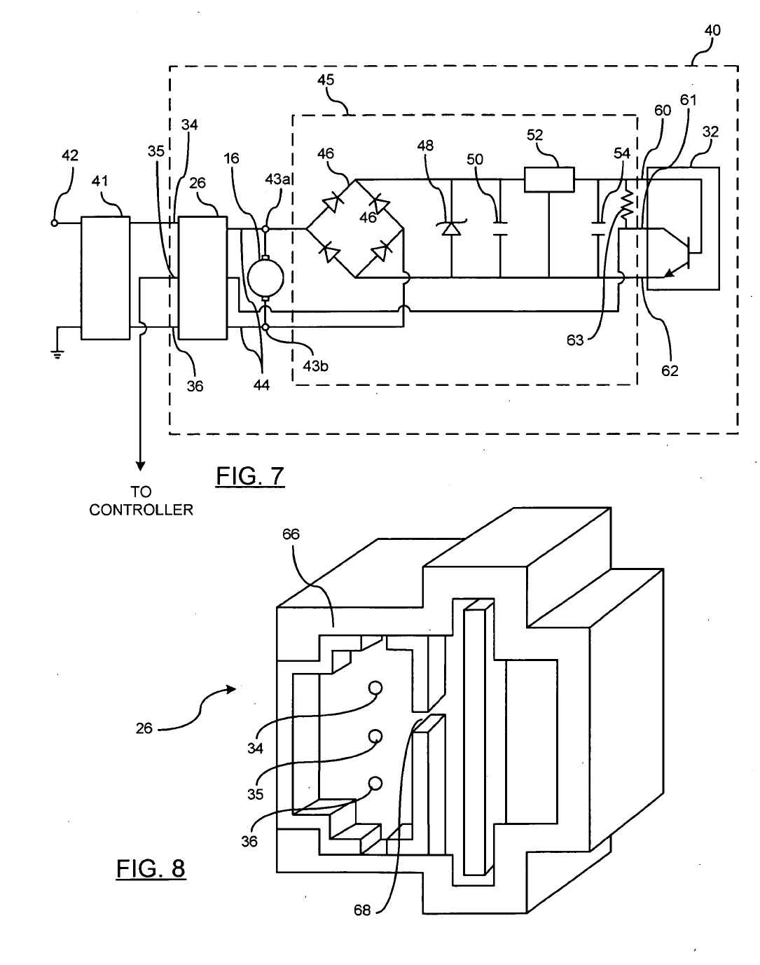

FIG. 8 illustrates a perspective view of the connector 26 according to a preferred embodiment of the present invention. The connector 26 includes an outer plastic shell 66 that is either secured to the gear cover 20 or secured to the yoke housing 17. The connector 26 may include a key 68 so that a mating connector (not shown) is orientated correctly for interlocking both connectors. In the preferred embodiment, the connector 26 is integrated as part of the gear cover 20 (shown in FIG. 3). The connector 26 includes the first, second, and third contact terminals 34, 35, and 36, respectively. The bipolar input voltage is received through connector 26 and is directed to energize the electromagnetic armature 14 and to the conversion circuit 45 for powering the position encoder 32 (shown in FIG. 7). The position signal identifying the rotational position of the gear member 16 is output through connector 26 to a controller. As a result, additional circuits that required additional wiring and contact terminals to separately supply input voltage for energizing the electromagnetic armature 14 and the position encoder 32 are eliminated with the implementation of the conversion circuit 45 within the motor housing 12. Preferably, the conversion circuit 45 is integrated within the gear cover 20. However, the conversion circuit 45 may be packaged in locations other than the motor housing 12 that are feasible for packaging.

In accordance with the provisions of the patent statutes, the principle and mode of operation of this invention have been explained and illustrated in its preferred embodiment. For example, the present invention may be used within an AC motor with minor modifications without departing from the scope of the invention. It must be understood that this invention may be practiced otherwise than as specifically explained and illustrated without departing from its spirit or scope.

What is claimed is:

1. A DC motor circuit for an automobile accessory comprising:
biplolar input lines for driving an accessory motor;
a bridge rectifier coupled to said bipolar input lines for generating a unipolar output;
a transient voltage suppressor connected in parallel with said bridge rectifier;
a voltage regulator coupled to said unipolar output for generating a regulated DC voltage; and
a position encoder powered by said regulated DC voltage.

2. The DC motor circuit of claim 1 wherein said position encoder sensor includes a non-contact position sensor.

3. The DC motor circuit of claim 1 wherein said non-contact position sensor includes a hall-effect sensor.

4. The DC motor circuit of claim 1 wherein said non-contact position sensor includes a potentiometer.

5. The DC motor circuit of claim 1 further comprising a connector having a first terminal contact, a second terminal contact, and a third terminal contact, wherein said first and second terminal contacts receive a bipolar voltage for energizing said motor, and said third terminal contact conducts a sensed position signal identifying a sensed motor position.

6. The DC motor circuit of claim 1 further comprising an energy storage device for storing said rectified voltage from said bridge rectifier.

7. A motor assembly comprising:
a DC electric motor including an electromagnetic armature for generating an electromagnetic field;
a gear member operatively coupled to said electromagnetic armature;
a housing enclosing said DC electric motor and said gear member;
a position encoder for determining a rotational position of said gear member;
a connector having a first terminal contact, a second terminal contact, and a third terminal contact, said first and second terminal being connected to bipolar input lines for receiving a bipolar voltage from an external source for energizing said motor, and said third terminal contact conducting a rotational position signal sensed by said position encoder; and
a DC motor circuit for powering said position encoder, said DC motor circuit comprising:
a bridge rectifier coupled to said bipolar input lines for generating a unipolar output; and
a voltage regulator coupled to said unipolar output for generating a regulated DC voltage;
wherein said regulated DC voltage is output to said position encoder, and wherein said position encoder generates said rotational position signal indicative of said rotational position of said gear member.

8. The motor assembly of claim 7 wherein said DC motor circuit further includes a transient voltage suppressor connected in parallel with said bridge rectifier for suppressing voltage increases.

9. The motor assembly of claim 7 wherein said position encoder sensor comprises a non-contact position sensor.

10. The motor assembly of claim 7 wherein said non-contact position sensor comprises a hall-effect sensor.

11. The motor assembly of claim 7 wherein said non-contact position sensor includes a potentiometer.

12. The motor assembly of claim 7 wherein said DC motor circuit is integrated within said motor housing.

13. A method for powering a position encoder in a motor utilizing a bipolar motor input supply voltage, said method comprising the steps of:
inputting a bipolar voltage for energizing an accessory motor;
rectifying said input bipolar voltage for generating a unipolar output;
regulating said unipolar output for generating a regulated DC voltage output; and
energizing said position encoder with said regulated DC voltage output for sensing a rotational position of said motor.

14. The method of claim 13 further comprising the step of outputting a rotational position signal in response to energizing said position encoder.

15. The method of claim 13 further comprising the step of suppressing predetermined voltage increases across said unipolar output.

16. The method of claim 13 wherein said rectified voltage is stored in an energy storage device.

17. The method of claim 13 wherein said step of inputting said bipolar voltage includes inputting a switchable bipolar voltage.
